(19) United States
(12) Patent Application Publication
(10) Pub. No.: US 2015/0280321 A1
(43) Pub. Date: Oct. 1, 2015

(54) LOW POWER MULTI-GIGABIT PER SECOND MILLIMETER-WAVE DATA-LINK EMPLOYING MODULATED REFLECTIONS

(71) Applicant: CALIFORNIA INSTITUTE OF TECHNOLOGY, Pasadena, CA (US)

(72) Inventors: Adrian J. Tang, Pasadena, CA (US); Nacer E. Chahat, Pasadena, CA (US); Goutam Chattopadhyay, Pasadena, CA (US); Choonsup Lee, La Palma, CA (US)

(21) Appl. No.: 14/675,319

(22) Filed: Mar. 31, 2015

Related U.S. Application Data
(60) Provisional application No. 61/972,623, filed on Mar. 31, 2014.

(51) Int. Cl. H01Q 3/46

(52) U.S. Cl. CPC H01Q 3/46

(57) ABSTRACT

A system for wirelessly communicating between a base station and a mobile device, including a reflector integrated with a mobile device, wherein the reflector reflects carrier radiation transmitted from a base station, to form a reflection of the carrier radiation, and input data from the mobile device modulates a reflection coefficient of the reflector, thereby modulating the reflection such that the reflection of the carrier radiation carries the input data to the base station.

### CROSS REFERENCE TO RELATED APPLICATIONS

This application claims the benefit under 35 U.S.C. Section 119(e) of co-pending and commonly-assigned U.S. Provisional Patent Application Ser. No. 61/972,623, filed on Mar. 31, 2014, by Adrian Tang, Nacer E. Chahat, Goutam Chattopadhyay, and Choonsup Lee entitled “LOW POWER MULTI-GB/S MM-WAVE DATA-LINK EMPLOYING MODULATED REFLECTIONS,” client reference number CIT-6506-P, which application is incorporated by reference herein.

### STATEMENT REGARDING FEDERALLY SPONSORED RESEARCH AND DEVELOPMENT

The invention described herein was made in the performance of work under a NASA contract, and is subject to the provisions of Public Law 96-517 (35 USC 202) in which the Contractor has elected to retain title.

### BACKGROUND OF THE INVENTION

1. Field of the Invention

This invention relates to a data link.

2. Description of the Related Art

(Note: This application references a number of different publications as indicated throughout the specification by one or more reference numbers within brackets, e.g., [x]. A list of these different publications ordered according to these reference numbers can be found below in the section entitled “References.” Each of these publications is incorporated by reference herein.)

While millimeter wave (mm-wave) wireless communications in Complementary Metal Oxide Semiconductor (CMOS) technology offers the advantages of extremely high data rates (>10 Gigabits per second (GB/s)) at low product costs, the technology intrinsically exhibits high power consumption as mm-wave transmitters have limited power efficiency (1-10%) (see [1-3]). This high power consumption greatly limits the battery life of a portable mm-wave device and creates a barrier to entry into the mobile devices market (e.g., smartphones, tablets and personal digital assistants (PDAs)).

### SUMMARY OF THE INVENTION

One or more embodiments of the invention disclose a system providing a wireless data link between a base station and a mobile device, comprising a reflector (e.g., antenna) integrated with a mobile device, wherein the reflector reflects carrier radiation incident from a base station to form a reflection of the carrier radiation, and input data from the mobile device modulates a reflection coefficient of the reflector, thereby modulating the reflection such that the reflection of the carrier radiation carries the input data to the base station.

The carrier radiation can comprise millimeter wave radiation, e.g., having a wavelength in a range of 1-10 mm and/or a frequency in a range of 30-300 GHz.

The system can further comprise a modulator (e.g., switch) connected to the reflector and integrated in the mobile device, wherein the modulator modulates the reflection coefficient according to the input data.

The input data can comprise a digital signal having a first state and a second state, the reflection coefficient can be switched between a first reflection state and a second reflection state, the modulator can switch the reflection coefficient to the first reflection state when digital signal is in the first state, and the modulator can switch the reflection coefficient to the second reflection state when the digital signal is in the second state.

The reflector and modulator together can consume less than 1 milliwatt of power. The modulator can modulate the reflection such that the input data comprises a data rate of at least 1 Giga bit per second.

The input data can comprise voice, video, text, and/or internet data. The reflection can be modulated by amplitude-shift keying, frequency-shift keying, and/or phase-shift keying. The input data can be modulated for transmission using a Wireless Gigabit Alliance (WiGiG) standard or IEEE mm-wave standard.

The reflection coefficient can modulate an electromagnetic field distribution, phase, frequency, amplitude, and/or timing of the reflection.

The system can further comprise a base station, wherein the base station comprises a source of the carrier radiation and a receiver for the reflection. The source can generate the carrier radiation with sufficient power, and/or the receiver can receive the reflection with sufficient sensitivity, such that the input data can be read from the reflection received at the base station.

The base station can transmit the carrier radiation having a power that is at least 4 times higher as compared to in a system comprising mobile device having a transmitter that generates the carrier radiation.

The base station can comprise a cell tower in a cellular mobile telephone network and the reflection can carry the input data modulated according to a cell phone transmission multiplexing protocol.

### BRIEF DESCRIPTION OF THE DRAWINGS

Referring now to the drawings in which like reference numbers represent corresponding parts throughout:

FIG. 1 is a schematic of a conventional data link.

FIG. 2 is a schematic of a data link between a base station and mobile device, according to one or more embodiments of the invention.

FIG. 3 illustrates a concept of operation, according to one or more embodiments of the invention, wherein the illuminator at the base-station end illuminates the mobile device with mm-wave illumination.

FIG. 4 is a system level illustration of a mobile communication device according to one or more embodiments of the invention.

FIG. 5 illustrates examples of waveforms that could be modulated into the reflected carrier wave by modulating the reflection coefficient of a reflector according to one or more embodiments of the invention, illustrating (a) amplitude-shift keying (ASK), (b) frequency-shift keying (FSK), and (c) phase-shift keying (PSK).

FIG. 6 illustrates a base station according to one or more embodiments of the invention.

FIG. 7 is an exemplary hardware and software environment used to implement one or more embodiments of the invention.

FIG. 8 schematically illustrates a typical distributed computer system using a wireless network according to one or more embodiments of the invention.

FIG. 9 is a flowchart illustrating a method according to one or more embodiments of the invention.

FIG. 10 illustrates a switching device connected to an antenna, according to one or more embodiments of the invention.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

One or more embodiments of the invention disclose a multi-gigabit per second mm-wave data link between a fixed base-station and mobile device based upon signal reflection at the mobile device end.

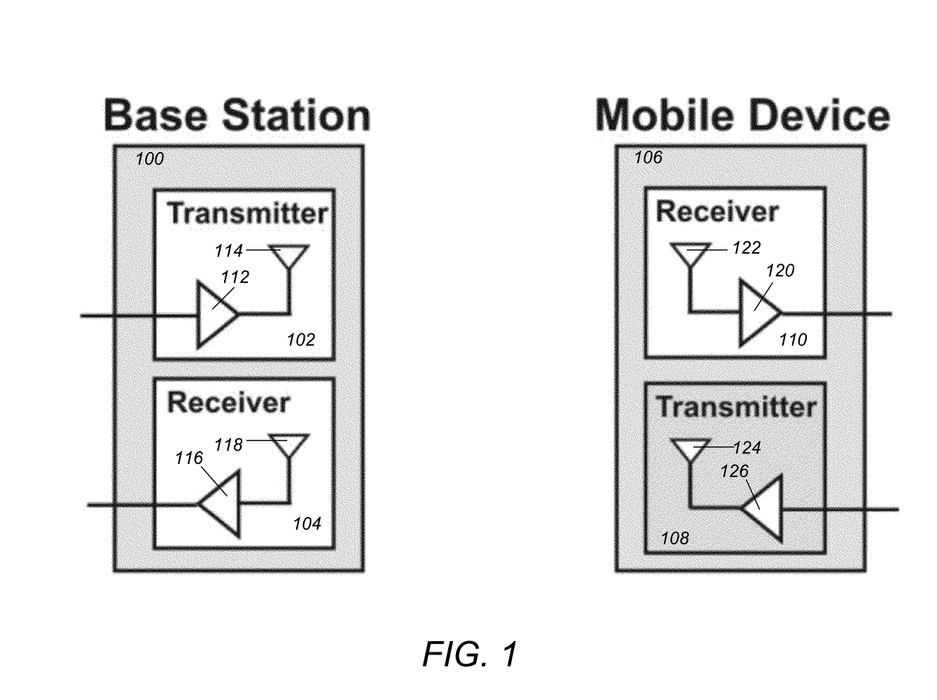

FIG. 1 illustrates a conventional data link between a base station 100, comprising transmitter 102 and receiver 104, and a mobile device 106, comprising transmitter 108 and receiver 110. Transmitter 102 comprises amplifier 112 and antenna 114, receiver 104 comprises amplifier 116 and antenna 118, receiver 110 comprises amplifier 120 and antenna 122, and transmitter 108 comprises antenna 124 and amplifier 126. The conventional data link requires a power-hungry transmitter 102, 108 at each end of the data-link. This means that in a conventional link, the mobile device 106 must contain a transmitter 108 and therefore exhibit high power consumption and low battery life.

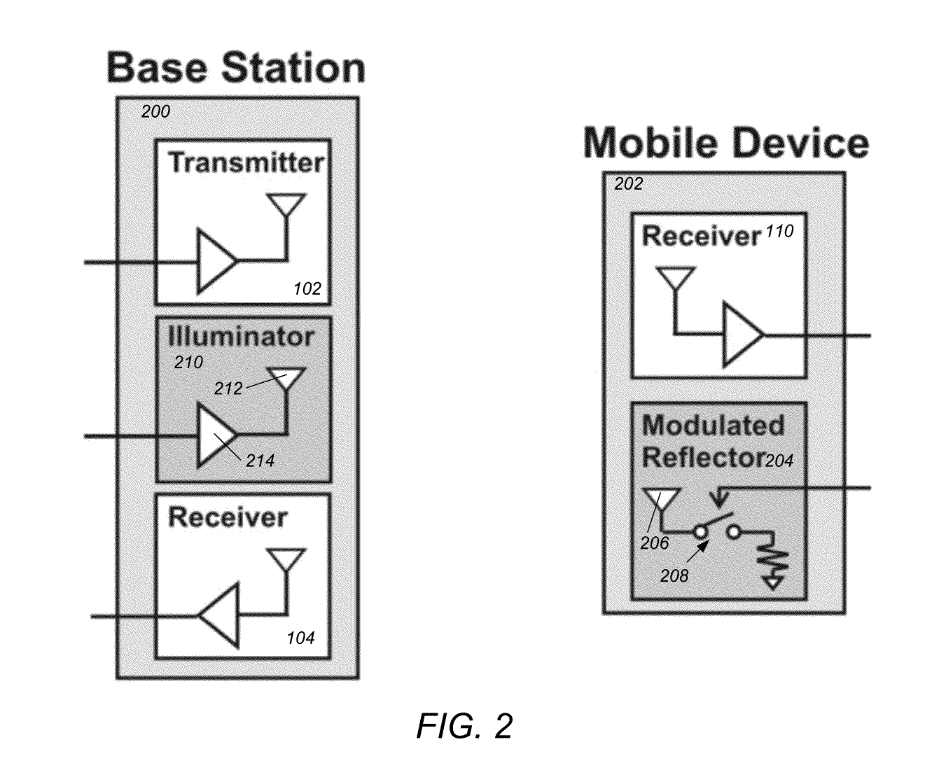

FIG. 2 illustrates a data link between a base station 200 and mobile device 202 according to one or more embodiments of the invention, wherein the mobile device 202 does not contain a conventional transmitter but instead contains a modulated reflector 204 comprising an antenna 206 (e.g, patch antenna or dipolar patch antenna) whose reflection coefficient can be switched between two states using a switch or switching device 208. The receiver 110 remains unchanged. An illuminator 210, comprising antenna 212 and amplifier 214, is added to the base station 200, wherein the illuminator 210 shines an unmodulated mm-wave signal on the mobile device 202.

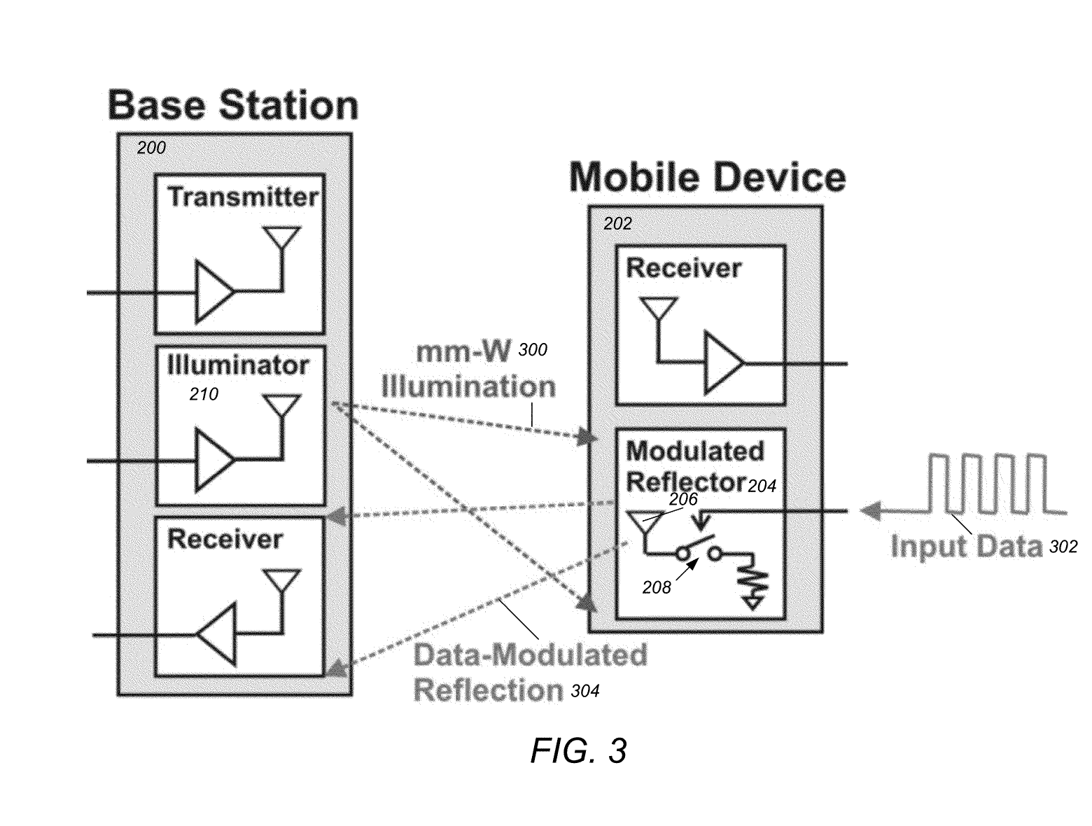

FIG. 3 illustrates the concept of operation according to one or more embodiments of the invention, wherein the illuminator 210 at the base-station 200 end illuminates the mobile device 202 with mm-wave illumination 300. The antenna 206 reflection coefficient is modulated with the input data 302 to be transmitted and therefore returns a data modulated reflection 304 to the base-station 200.

As the power consumption of a switch or switching device 208 is 2-3 orders lower than a transmitter 108, this approach overcomes the high power consumption of CMOS mm-wave transmitters and enables the technology's entry into the mobile market. For example, a transmitter 108 in a conventional mobile device 106 can consume more than 100 milliwatts (mW) of power, whereas the modulated reflector 204 according to one or more embodiments can consume less than 1 mW of power.

This is the first reported concept of a mm-wave communication link based upon reflection and the only reported approach which overcomes the high power consumption of mm-wave transmitters specifically for the mobile device market.

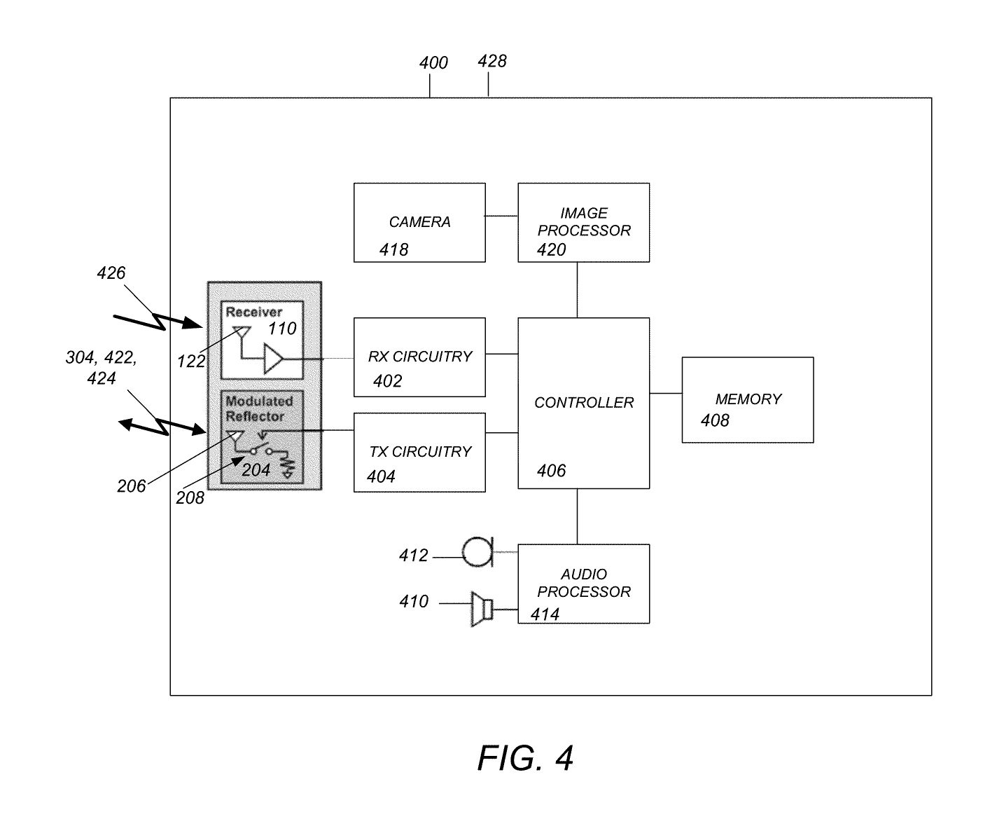

FIG. 4 is a system level illustration of a communication device 400 (e.g., mobile device) according to one or more embodiments, comprising receiver 110, modulated reflector 204, receiver (RX) circuitry 402, transmitter (TX) circuitry 404 (e.g., comprising switching device 208), controller/processor 406, memory 408, speaker 410, microphone 412, audio processor 414, camera 418, and image processor 420.

Camera 418, microphone 412, speaker 410, audio processing 414, and image processing 420 can function and comprise components as necessary to interface with computers or displays and modulators/demodulators in controller 406 or circuitry 402, 404.

Speech, voice, or other audio input received from a user through the microphone 412, or video or image input received from a camera 418, can be encoded and/or compressed, e.g., in the audio processor 414 and image processor 420, respectively, to obtain input data (typically digital data) that can be processed by controller 406 or other computer processor such as modulator in TX circuitry 404. Audio processor 414 can comprise audio codec to encode audio data and image processor 420 can comprise image and/or video codec to encode image/video data. Input data can also comprise text inputted by user through a keyboard and processed into a format accepted by processor or controller 406.

The input data can be modulated or converted by the TX circuitry 404 or controller 406 comprising modulator (e.g., digital signal processor) into data capable of wireless transmission over a wireless network (e.g., transmission or communication using a wireless standard, protocol, or technology, including, but not limited to, second generation (2G), third generation (3G), fourth generation (4G) Long Term Evolution (4G LTE), packet switching, Global System for Mobile Communications (GSM), Enhanced Data GSM Environment (EDGE), wideband code division multiple access (W-CDMA), code division multiple access (CDMA), Multi-carrier CDMA (MC-CDMA), time division multiple access (TDMA), frequency division multiple access (FDMA), Orthogonal FDMA (OFDMA), Single Carrier FDMA (SC-FDMA), Interleaved FDMA, Bluetooth, Wireless Fidelity (Wi-Fi) (e.g., IEEE 802.11a, IEEE 802.11b, IEEE 802.11g and/or IEEE 802.11n), Wireless Gigabit Alliance (WiGiG) or Institute of Electrical and Electronics Engineers (IEEE) mm-wave (e.g., 802.15.3c and/or 802.11.ad), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS), or other protocol).

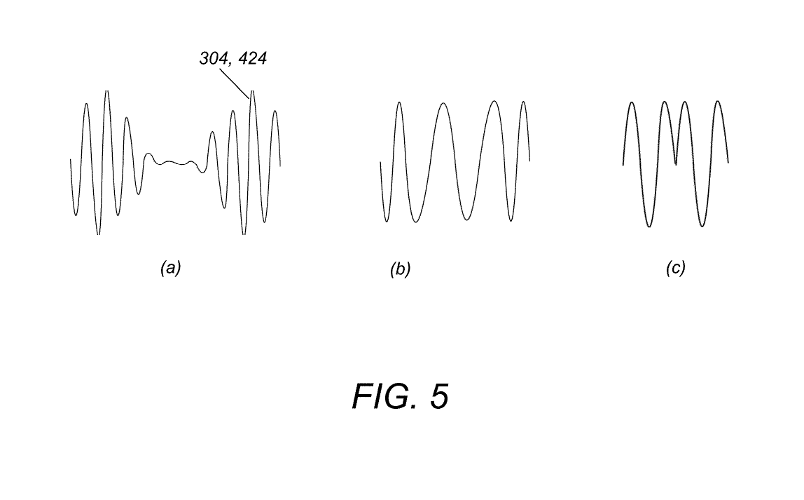

The input data modulated (e.g., according to the wireless standard above) is used to switch (using switch or switching device 208 or other circuitry in TX circuitry 404) the reflection coefficient of the antenna 206, thereby modulating the carrier wave radiation or illumination 300, 422 (e.g., electromagnetic radiation, e.g., having a frequency in a range of 3 kHz-900 GHz, Radio Frequency (RF), or having a wavelength in a range of 0.5 millimeters-1000 millimeters, for example) with the input data (e.g., 302) to form data modulated reflection 304, 424. The TX switch 208 or circuitry 404 can perform analog modulation and/or digital modulation of the carrier illumination 300, 422 to modulate the reflection coefficient, e.g., according to the above protocols. For example, the modulation of the carrier wave illumination 300, 422 by the TX circuitry 404 or switch 208 can comprise phase-shift keying (PSK), frequency shift keying (FSK), amplitude-shift keying (ASK), On Off Keying (OOK), or combinations of PSK, FSK, and/or ASK such as quadrature amplitude modulation (QAM) or IQ modulation, where I is the in phase component and Q is the quadrature component of the carrier wave illumination 300, 422, e.g. using adders or mixers or other components to perform these functions. FIG. 5 illustrates an example of the modulated carrier wave 304, 424 obtained by modulating the reflection coefficient using (a) ASK, (b), FSK, and (c) PSK. On-Off Keying (OOK) can also be used.

Processing of the received carrier signal 426 (e.g., electromagnetic radiation, e.g., having a frequency in a range of 3 kHz-900 GHz, Radio Frequency (RF), or having a wavelength in a range of 0.5 millimeters-1000 millimeters, for example) can be performed. The RX circuitry 402 converts the RF electromagnetic signals 426, e.g., modulated according to the wireless transmission protocols discussed above, received in the antenna 122, to electrical signals. For example, the receiver circuitry 402 can amplify and down convert the RF signal received at the antenna 122 to Intermediate Frequency signal and then to baseband signal, e.g., using circuitry for performing these functions, e.g., amplifier(s), tuner(s), mixer(s) and oscillator(s). The receiver circuitry 402 and/or controller 406 can demodulate the received signal (e.g., baseband signal) to extract and read the data carried by the carrier radiation 422, to obtain data that can be processed by the computer processors 406 and codecs. The receiver circuitry 402 and/or portion of the controller 406 that handles the received signal can be processors or circuitry, e.g., an analog baseband processor and mobile station modem, WIFI module or modem, or Bluetooth module or modem.

Audio data (e.g. speech, voice), and/or image data (e.g., video) carried by received signal 422 and demodulated or processed by the receiver circuitry 402/controller 406 can be decoded and/or decompressed e.g., in the audio processor 414 and image processor 420, respectively, to obtain data (typically digital data) that can be processed e.g., by other computer processor and/or for output by speaker 410 or display. Audio processor 414 can comprise audio codec to decode audio data and image processor 420 can comprise image and/or video codec to decode the image data.

Processors/Circuitry 402, 404 (e.g., comprising switching device 208), 406 can be implemented in one or more chips, digital signal processors, integrated circuits, application specific integrated circuits (ASIC), Field Programmable Gate Arrays (FPGA), and complementary metal oxide semiconductor (CMOS). For example, switching device 208 can comprise one or more transistor based circuits, e.g., based in CMOS.

Thus, the radiation 422, 424, 426, 304 and circuitry 402, 404 may be compatible to wirelessly communicate with networks (e.g., Internet, World Wide Web (WWW), intranet, cellular telephone network, a wireless local area network (LAN), metropolitan area network (MAN)) or other devices.

The antenna 206 used as the modulated reflector 204 and the antenna 122 used to receive signals can be the same antenna or different antennas. The antenna 206 and/or 122 can be integrated within the case 428 of the device 400 or attached to an outside of the case 424, for example. The device 400 can comprise multiple antennas 206/122 and associated circuitry 402, 404 so that the device can communicate using multiple protocols (e.g., WIFI, RF, Bluetooth).

The controller 406 further controls the overall operation of the communication device 400, including timing of the received 426 and transmitted or reflected 424,304 signals, and interfacing with the base station 200. Interfacing of the device 400 (e.g., mobile device 202) with the mobile network base station 200 and Mobile Telephone Switching Office (MTSO), including enabling the mobile device to register, make and receive calls, terminate calls, channel changing, and handle or coordinate the handovers that are needed when the device 400 or mobile device 200 moves from one cell to another, cellular System Information Codes, can be implemented. Memory 408 can comprise a subscriber identity module (SIM) card.

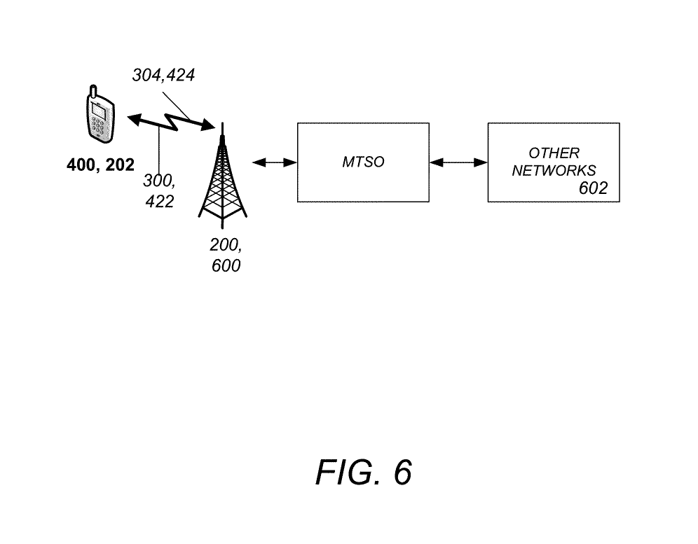

FIG. 6 illustrates a base station 200, 600 according to one or more embodiments that can be implemented wherein the base station 200, 600 contains/comprises circuitry to transmit the carrier wave 300, 422 with sufficient power and/or detect the reflected carrier wave 304,424 with sufficient sensitivity, such that the carrier wave 304,424 reflected from the modulated reflector 204 can be received by the base station 200,600 and the data modulated into the data modulated reflection 304,424 can be read by the base station and/or other networks 602 in communication with the base station 200,600. The base station 200, 600 can decode or demodulate the carrier wave 304 to obtain the data in accordance with the wireless standards, protocols, and technologies discussed above. The base station can transmit the data to other networks 602, including, but not limited to, Publicly Switched Telephone Networks (PSTN) and Internet Protocol (IP) networks.

Further Hardware Environment

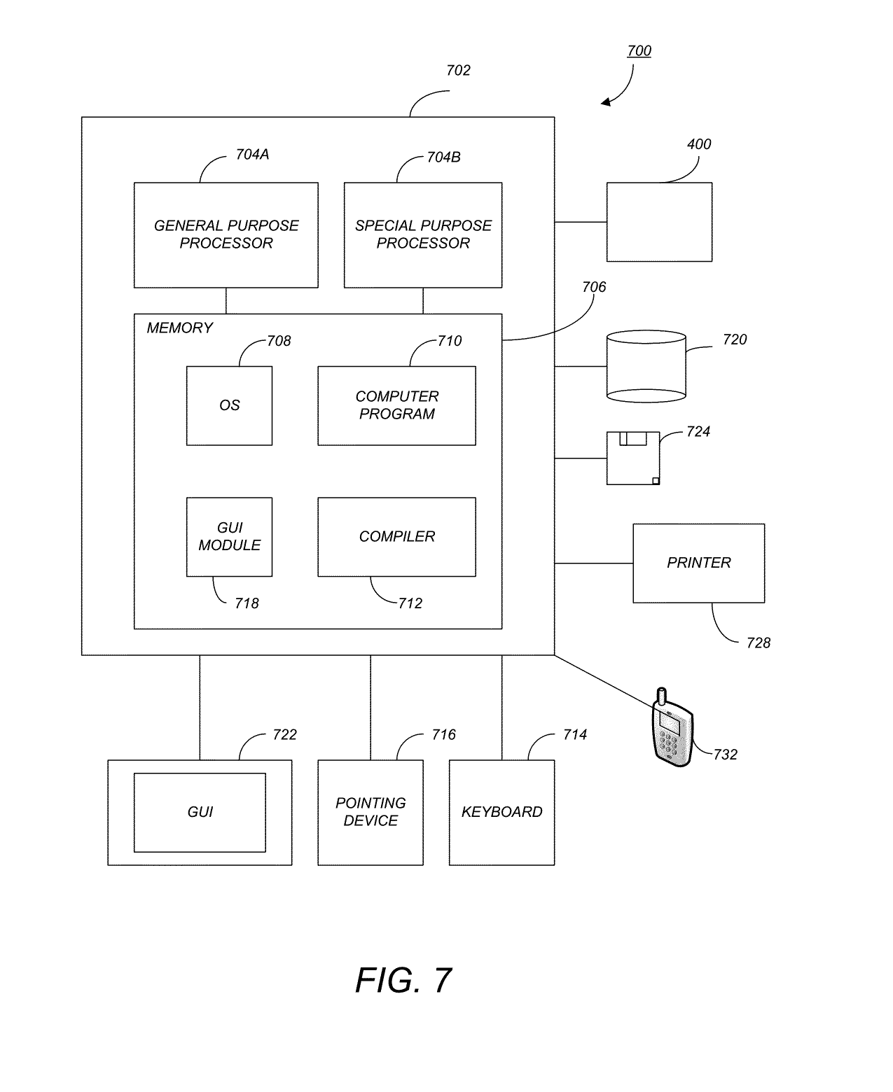

FIG. 7 is an exemplary hardware and software environment 700 used to implement one or more embodiments of the invention. The hardware and software environment includes a computer 702 and may include peripherals. Computer 702 may be a user/client computer, server computer, or may be a database computer. The computer 702 comprises a general purpose hardware processor 704A and/or a special purpose hardware processor 704B (hereinafter alternatively collectively referred to as processor 704) and a memory 706, such as random access memory (RAM). The computer 702 may be coupled to, and/or integrated with, other devices, including input/output (I/O) devices such as a keyboard 714, a cursor control device 716 (e.g., a mouse, a pointing device, pen and tablet, touch screen, multi-touch device, etc.) and a printer 728. In one or more embodiments, computer 702 may be coupled to, or may comprise, a portable or media viewing/listening device 732 (e.g., an MP3 player, iPod™, Nook™, portable digital video player, cellular device, personal digital assistant, etc.). In yet another embodiment, the computer 702 may comprise a multi-touch device, mobile phone, gaming system, internet enabled television, television set top box, or other internet enabled device executing on various platforms and operating systems. The device 732 wirelessly transmits data using the modulated reflector 204 described above.

In one embodiment, the computer 702 operates by the general purpose processor 704A performing instructions defined by the computer program 710 under control of an operating system 708. The computer program 710 and/or the operating system 708 may be stored in the memory 706 and may interface with the user and/or other devices to accept input and commands and, based on such input and commands and the instructions defined by the computer program 710 and operating system 708, to provide output and results.

Output/results may be presented on the display 722 or provided to another device for presentation or further processing or action. In one embodiment, the display 722 comprises a liquid crystal display (LCD) having a plurality of separately addressable liquid crystals. Alternatively, the display 722 may comprise a light emitting diode (LED) display having clusters of red, green and blue diodes driven together to form full-color pixels. Each liquid crystal or pixel of the display 722 changes to an opaque or translucent state to form a part of the image on the display in response to the data or information generated by the processor 704 from the application of the instructions of the computer program 710 and/or operating system 708 to the input and commands. The image may be provided through a graphical user interface (GUI) module 718. Although the GUI module 718 is depicted as a separate module, the instructions performing the GUI functions can be resident or distributed in the operating system 708, the computer program 710, or implemented with special purpose memory and processors.

In one or more embodiments, the display 722 is integrated with/into the computer 702 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™ Droid™ devices, Samsung Galaxy™ etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 702 according to the computer program 710 instructions may be implemented in a special purpose processor 704B. In this embodiment, the some or all of the computer program 710 instructions may be implemented via firmware instructions stored in a read only memory (ROM), a programmable read only memory (PROM) or flash memory within the special purpose processor 704B or in memory 706. The special purpose processor 704B may also be hardwired through circuit design to perform some or all of the operations to implement the present invention. Further, the special purpose processor 704B may be a hybrid processor, which includes dedicated circuitry for performing a subset of functions, and other circuits for performing more general functions such as responding to computer program 710 instructions. In one embodiment, the special purpose processor 704B is an application specific integrated circuit (ASIC).

The computer 702 may also implement a compiler 712 that allows an application or computer program 710 written in a programming language such as COBOL, Pascal, C++, FORTRAN, or other language to be translated into processor 704 readable code.

Alternatively, the compiler 712 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 710 accesses and manipulates data accepted from I/O devices and stored in the memory 706 of the computer 702 using the relationships and logic that were generated using the compiler 712.

The computer 702 also comprises or is connected to the communication device or module 400 (e.g., comprising modulated reflector 204 including switching device 208 and antenna 206) and other communication devices such as a modem, satellite link, Ethernet card, or other device, for accepting input from, and providing output to, other computers or base station 200. In one or more embodiments, one or more of the processors 704 comprise one or more of the circuitry 404, controller 406, 408, and processors 420, 414 of the communications module 400. Rx circuitry 402 can also be implemented by one of the processors 704 and/or in separate circuitry. In one or more embodiments the receiver 110 and modulated reflector 204 are enclosed within, attached to, or integrated with case or enclosure for computer 702. Processor 704 can also operate applications as typically performed by mobile devices.

In one embodiment, instructions implementing the operating system 708, the computer program 710, and the compiler 712 are tangibly embodied in a non-transitory computer-readable medium, e.g., data storage device 720, which could include one or more fixed or removable data storage devices, such as a zip drive, floppy disc drive 724, hard drive, CD-ROM drive, tape drive, etc. Further, the operating system 708 and the computer program 710 are comprised of computer program 710 instructions which, when accessed, read and executed by the computer 702, cause the computer 702 to perform the steps necessary to implement and/or use the present invention or to load the program of instructions into a memory 706, thus creating a special purpose data structure causing the computer 702 to operate as a specially programmed computer executing the method steps described herein. Computer program 710 and/or operating instructions may also be tangibly embodied in memory 706 and/or data communications devices 400, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 702.

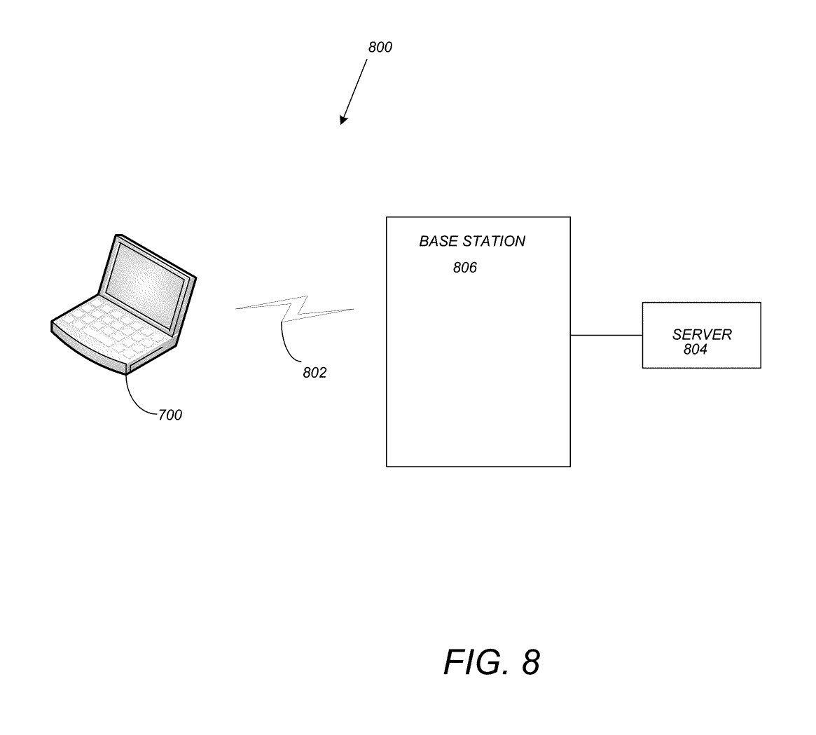

FIG. 8 schematically illustrates a typical distributed computer system 800 using a wireless network 802 comprising illumination 300, 422 and reflected carrier radiation 304,424 to connect client computers 700 to server computers 804 via a base station 806. A typical combination of resources may include a network comprising the Internet, LANs (local area networks), WANs (wide area networks), SNA (systems network architecture) networks, or the like, clients 700 that are personal computers or workstations (as set forth in FIG. 7), and servers 804 that are personal computers, workstations, minicomputers, or mainframes (as set forth in FIG. 7). However, it may be noted that different wireless networks such as a cellular network (e.g., GSM [global system for mobile communications] or otherwise), a satellite based network, or any other type of network may be used to connect clients 700 and servers 804 in accordance with embodiments of the invention. For example, base station 806 can comprise a WIFI or Bluetooth module.

Although the terms “user computer”, “client computer”, and/or “server computer” are referred to herein, it is understood that such computers 700 and 804 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 700 and 804.

Software Embodiment Overview

Embodiments of the invention are implemented as a software application on a client 700 or server computer 804. Further, as described above, the client 700 or server computer 804 may comprise a thin client device or a portable device that has a multi-touch-based display.

Process Steps

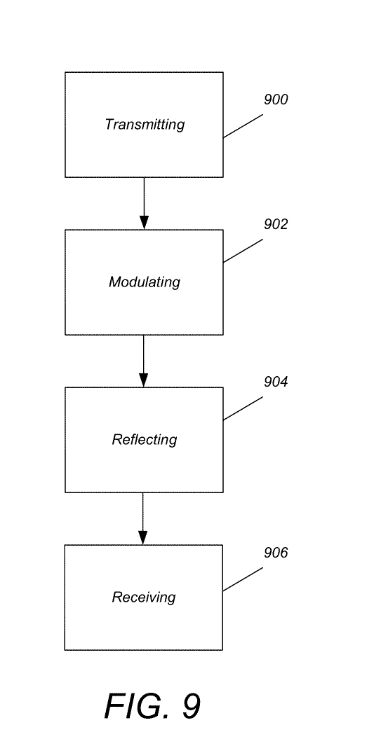

FIG. 9 is a flowchart illustrating a method of operating or fabricating a system for wirelessly communicating between a base station and a device (e.g., a desktop computer or mobile device such as, but not limited to, laptop computer, handheld computer, portable computer, tablet device, cell/mobile/portable phone, handset, smartphone).

Block 900 represents providing means (e.g., source, illuminator) for transmitting carrier radiation (Electromagnetic (EM) Radiation) to the (e.g., communication) device. The electromagnetic radiation can have a frequency in a range of 3 kHz-900 GHz, can comprise Radio Frequency (RF), a wavelength in a range of 0.5 millimeters-1000 millimeters, radiation in a mm-wave frequency regime, radiation having a wavelength in range of 1-10 mm and/or a frequency in a range of 30-300 GHz, or wavelength/frequency suitable for communicating in networks described throughout this disclosure, for example.

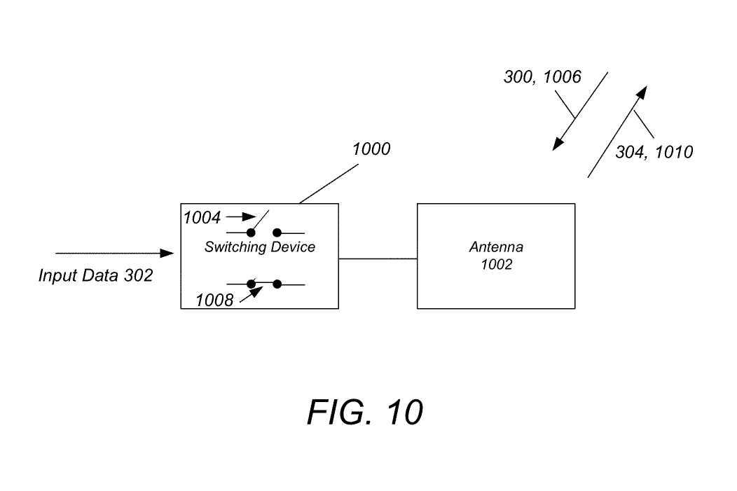

Block 902 represents providing a modulator or means for modulating (e.g., switch, switching system or switching device 1000, as illustrated in FIG. 10) a reflector. The modulator can be integrated with the device and modulate the reflection coefficient of the reflector according to input data from the device. The input data can comprise a digital signal having a first state and a second state, the reflection coefficient can be switched between a first reflection state and a second reflection state, and the modulator can be used for switching the reflection coefficient to the first reflection state when the digital signal is in the first state and switching the reflection coefficient to the second reflection state when the digital signal is in a second state. The input data can comprise voice, video, text, and/or internet data. The input data can be modulated for transmission by a code division multiple access (CDMA) method, a time division multiple access (TDMA) method, and/or a frequency division multiple access (FDMA) method. The input data can be modulated for transmission using a 802.15.3c, 802.11.ad, WiGiG standard (IEEE mm-wave standard). The reflection can be modulated by amplitude-shift keying, frequency-shift keying, and/or phase-shift keying.

The modulator can modulate the reflection with analog or digital data (analog or digital modulation). The reflection coefficient can be modulated between two states or between multiple or continuous levels. The reflection coefficient can be modulated to form a sequence of pulses of the carrier radiation 304.

The modulator can modulate the reflection such that the input data comprises a data rate of at least 1 Giga bit per second.

Block 904 represents providing the reflector or means for reflecting (e.g., antenna 1002, as illustrated in FIG. 10). The reflector or means for reflecting can be integrated with the device and connected to the modulator. The reflector can be used for reflecting the carrier radiation transmitted/incident from a base station, to form a reflection of the carrier radiation modulated by the modulator in Block 902. Thus input data from the mobile device can be used to modulate the reflection coefficient of the reflector, thereby modulating the reflection such that the reflection of the carrier radiation carries the input data to the base station. The reflection coefficient can modulate an electromagnetic field (electric and/or magnetic field) distribution, phase, frequency, amplitude, and/or timing of the reflection. The reflection can be multiplexed using the CDMA, TDMA, FDMA multiplexing.

The reflector and modulator together can consume less than 1 milliwatt (mW) of power. The mobile device fabricated according to Blocks 902-904 can further comprise a battery and power management system providing the reflector and modulator with less than 1 mW of power.

FIG. 10 illustrates a switching device 1000 connected to an antenna 1002 according to one or more embodiments of the invention. The switching device 1000 can comprise a transistor, a plurality of transistors, or a system of transistors that switch the reflection coefficient of the antenna 1002 according to the input data (e.g., 302) to be transmitted. The antenna 1002 can be a patch antenna or dipolar patch antenna, for example. When the switching device 1000 is in an open state 1004, the carrier radiation (e.g., 300, 1006) from the base station incident on the antenna 1002 is reflected by the antenna 1002 (corresponding to one state of the reflection coefficient). When the switching device 1000 is in a closed state 1008, the antenna 1002 absorbs the incident power of the carrier radiation (e.g., 300, 1006) incident from the base station, thereby reducing or eliminating reflection of the carrier radiation (corresponding to another state of the reflection coefficient of the antenna). Thus, in one or more embodiments of the invention, the various states of the input data (e.g., binary 1 or 0) can switch the switching device 1000 between open 1004 and closed 1008 states, modulating the reflection coefficient of the antenna 1002 and the amplitude of the carrier radiation (e.g., 304, 1010) with the input data (e.g., ASK or On Off keying (OOK) modulation).

Block 906 represents providing means for receiving the reflection (e.g., receiver), wherein the receiver receives and demodulates the reflection with sufficient sensitivity such that the input data can be read from the reflection received at the base station.

A base station can comprise the illuminator/source, and receiver for the reflection. The source of the carrier radiation can generate the carrier radiation with sufficient power such that the input data can be read from the reflection received at the base station. The source can transmit the carrier radiation having a power that is higher (e.g., at least 4 times higher) as compared to in a system comprising a mobile device having a transmitter that generates the carrier radiation.

The input data read from the reflection by the base station can comprise a quality that meets or exceeds a quality of a 4G-LTE standard.

The base station can comprise a cell tower in a cellular mobile telephone network, a WIFI module, and/or Bluetooth module. The reflection can carry the input data modulated according to a wireless transmission multiplexing protocol.

### REFERENCES

The following references are incorporated by reference herein.
[1] Jenny Y. Liu, Adrian Tang, Ning-Yi Wang, Qun Jane Gu, R. Berenguer, H. Hsieh, P. Wu, C. Jou, M. F. Chang, “A V-band Self-Healing Power Amplifier with Adaptive Feedback Bias Control in 65 nm CMOS”, IEEE Radio Frequency Integrated Circuits Symposium (RFIC 2011), June 2011.
[2] K. Raczkowski, S. Thijs, W. D. Raedt, B. Nauwelaers, and P. Wambacq, “50-to-67 GHz ESD-protected power amplifiers in digital 45 nm LP CMOS, in IEEE Int. Solid-State Circuits Dig, February 2009, pp. 382-383.
[3] W. L. Chan, J. R. Long, M. Spirito, and J. J. Pekarik, “A 60 GHz-band 1 V 11.5 dBm power amplifier with 11% PAE in 65 nm CMOS, in IEEE Int. Solid-State Circuits Dig, February 2009, pp. 380-381.
[4] U.S. Pat. No. 7,698,711 by Joeng et. al.
[5] U.S. Pat. No. 7,864,163 by Ording et. al.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system providing a wireless data link between a base station and a mobile device, comprising:
a reflector integrated with a mobile device, wherein:
the reflector reflects carrier radiation incident from a base station to form a reflection of the carrier radiation, and
input data from the mobile device modulates a reflection coefficient of the reflector, thereby modulating the reflection such that the reflection of the carrier radiation carries the input data to the base station.

2. The system of claim 1, wherein the carrier radiation comprises millimeter wave radiation.

3. The system of claim 1, wherein the carrier radiation comprises millimeter wave radiation having a wavelength in a range of 1-10 mm and/or a frequency in a range of 30-300 GHz.

4. The system of claim 1, further comprising a modulator connected to the reflector and integrated in the mobile device, wherein the modulator modulates the reflection coefficient according to the input data.

5. The system of claim 4, wherein the reflector comprises an antenna.

6. The system of claim 5, wherein the modulator comprises a switching device.

7. The system of claim 5, wherein:
the input data comprises a digital signal having a first state and a second state,
the reflection coefficient is switched between a first reflection state and a second reflection state, and
the modulator switches the reflection coefficient to the first reflection state when digital signal is in the first state and switches the reflection coefficient to the second reflection state when the digital signal is in the second state.

8. The system of claim 4, wherein the reflector and modulator consume less than 1 milliwatt of power.

9. The system of claim 1, wherein the input data comprises voice, video, text, and/or internet data.

10. The system of claim 9, wherein the reflection is modulated by phase shift keying, frequency shift keying, and/or amplitude shift keying.

11. The system of claim 9, wherein the input data is modulated for transmission using a Wireless Gigabit Alliance (WiGiG) standard or IEEE mm-wave standard.

12. The system of claim 1, wherein the modulator modulates the reflection such that the input data comprises a data rate of at least 1 Giga bit per second.

13. The system of claim 1, wherein the reflection coefficient modulates an electromagnetic field distribution, phase, frequency, amplitude, and/or timing of the reflection.

14. The system of claim 1, further comprising:
a base station, wherein the base station comprises a source of the carrier radiation and a receiver for the reflection, wherein the source generates the carrier radiation with sufficient power and/or the receiver receives the reflection with sufficient sensitivity, such that the input data can be read from the reflection received at the base station.

15. The system of claim 14, wherein the base station transmits the carrier radiation having a power that is at least 4 times higher as compared to in a system comprising mobile device having a transmitter that generates the carrier radiation.

16. The system of claim 14, wherein the base station comprises a cell tower in a cellular mobile telephone network and the reflection carries the input data modulated according to a wireless transmission multiplexing protocol.

17. A mobile device, comprising:
a reflector, wherein:
the reflector reflects carrier radiation transmitted from a base station, to form a reflection of the carrier radiation, and
input data from the mobile device modulates a reflection coefficient of the reflector, thereby modulating the reflection such that the reflection of the carrier radiation carries the input data to the base station.

18. The mobile device of claim 17, wherein the carrier radiation comprises millimeter wave radiation.

19. A system for wirelessly communicating between a base station and a mobile device, comprising:
a base station comprising a source for transmitting carrier radiation to a reflector integrated in a mobile device, wherein:
the reflector reflects the carrier radiation to form a reflection of the carrier radiation, and
input data from the mobile device modulates a reflection coefficient of the reflector, thereby modulating the reflection such that the reflection of the carrier radiation carries the input data to the base station.

20. The system of claim 19, wherein the carrier radiation comprises millimeter wave radiation.
